(19) United States
(12) Patent Application Publication
(10) Pub. No.: US 2025/0312675 A1
(43) Pub. Date: Oct. 9, 2025

(54) Space Saving Equal-Stress Distributing Suspending Hanger

(71) Applicant: Mark Chang, Pittsburgh, PA (US)

(72) Inventor: Mark Chang, Pittsburgh, PA (US)

(21) Appl. No.: 19/242,918

(22) Filed: Jun. 18, 2025

Related U.S. Application Data
(63) Continuation-in-part of application No. 17/572,586, filed on Jan. 10, 2022, now abandoned.
(60) Provisional application No. 63/162,096, filed on Mar. 17, 2021.

(51) Int. Cl. A63B 69/22; A63B 69/20

(52) U.S. Cl. CPC A63B 69/222; A63B 69/305

(57) ABSTRACT

A space saving, equal-stress distributing suspending hanger which comprises a circular plate or metal bar arrangement with securing components from which an object can be suspended from and close to an overhead surface, thereby decreasing the amount of space between the overhead surface and the suspending hanger, and eliminating the need for traditional chains, straps, or ropes which place stress inwardly on the hanging points of the suspended object.

### CROSS-REFERENCE TO RELATED APPLICATIONS

This application is a continuation-in-part of pending U.S. patent application Ser. No. 17/572,586, filed Jan. 10, 2022, which claims the benefit of priority from U.S. Provisional Application 63/162,096, filed Mar. 17, 2021.

### FIELD OF INVENTION

The present invention relates hanger for suspending an object which both is saves space, particularly vertical space, and which enables equal stress distribution of the object being suspended. More specifically, the present invention relates to a suspension hanger for an object that facilitates stress at the hanging points of the object being vertically suspended, thereby eliminating any stress directed inwardly towards the center of the suspended in object. The suspended object may be a punching bag.

### BACKGROUND OF THE INVENTION

A punching bag is a sturdy bag designed to be repeatedly punched. Conventional punching bags are usually cylindrical and filled with a variety of materials to attain a desired hardness. Typical punching bags are four feet (4′) in height and with a cylindrical configuration. Such punching bags are usually suspended from a ceiling having a standard eight feet (8′) ceiling height with a traditional hanging chain or strap affixed to the top surface of the punching bag and suspended about two feet (2′) from the ceiling, thereby consuming about two feet of vertical space when accounting for the height of the mounting hardware required to secure the punching bag to the ceiling and the top of the punching bag is positioned just below six feet (6′). In this configuration, the center of the punching bag, which is the ideal punching area, is positioned at about four feet (4′) in height which is not the ideal position for a user who is taller than four feet (4′). Ideally, the center of the punching bag should be about six feet (6′) from the floor or ground surface.

In addition, the typically method of mounting and suspending a punching bag from a ceiling using traditional chains or straps results in the mounting points being pulled inwardly, resulting in pressure being placed on the top surface of the punching bag which in turn downwardly forces the filling contained within the punching bag into the lower portion of the punching bag. The result is a punching bag that is too soft at the top portion and to hard at the bottom portion.

### PRIOR ART

The prior art is replete with hanging and suspending devices. For example, U.S. Pat. No. 11,395,949 B1 to Brown discloses a suspension strap assembly for a punching bag that suspends a heavy bag in a manner appropriate for use for physical training for boxing activities, the assembly including a superior mount, a suspension apparatus, and a heavy punching bag having a plurality of sling webbing straps permanently attached to the upper portion of the heavy punching bag and permanently secured to a central ring which is connected to a suspension apparatus having a ceiling mounting bracket.

In U.S. Patent Application Publication 2015/0011366 A1 to Hockridge et al. suspension strap assembly for suspending a heavy punching bag from an overhead support. The assembly comprises a plurality of suspending straps affixed to the punching bag, each suspending strap having one end which engages a U-bolt rigidly secured to a central metal mounting plate with nuts to attach the each of the suspending straps to the plate and the mounting plate is attached to a hanging tube at a selected height using a locking pin or bolt. Brown notes that the bag height can be adjusted easily by releasing the locking pin, sliding the mounting plate up or down to the desired height, the re-inserting the locking pin through selectively aligned holes in the hanging tube. The hanging tube is attached to a universal joint or two-way pivot joint member via a pivot bracket while an upper hanging shaft is attached to the upper end of a two-way pivot joint via a second pivot joint bracket at its lower end.

U.S. Pat. No. 8,740,171 B2 to Crescenzo, U.S. Pat. No. 9,123,018 B2 to Gentille et al., and U.S. Pat. No. 9,651,195 B2 to Chang et al. all disclose systems for hanging or suspending objects from a wall or other vertical surface, rather than suspending an object from an overhead hanging point.

### SUMMARY OF THE INVENTION

The invention of the present subject matter relates to a space saving, equal-stress distributing suspending hanger of the present subject matter comprising a circular plate or metal bar arrangement with securing components from which an object can be suspended from and close to an overhead surface, thereby decreasing the amount of space between the overhead surface and the suspending hanger, and eliminating the need for traditional chains, straps, or ropes which place stress inwardly on the hanging points of the suspended object.

Accordingly, it is an object of the present subject matter to provide a space saving, equal-stress distributing suspending hanger which eliminates the need for traditional chains, straps, or ropes which place stress inwardly on the hanging points of the suspended object.

It is another object of the present subject matter to provide a space saving, equal-stress distributing suspending hanger which substantially decreases the vertical hanging distance required by a single ceiling mount using chains, straps, or rope, enabling an object to be suspended from a lower vertical point, for example enabling a punching bag to be hung from a lower height than the average height of a standard ceiling.

It is still another object of the present subject matter to provide a space saving, equal-stress distributing suspending hanger which suspends an object directly upwards at the hanging points, such that the stress on the object is only at the hanging points, resulting in no force pulling the upper sides of the object inwardly towards the center.

It is a yet another object of the present subject matter to provide a space saving, equal-stress distributing suspending hanger which achieves saving of vertical space about between the suspending hanger and the overhead surface.

It is a further object of the present subject matter to provide a space saving, equal-stress distributing suspending hanger which achieves equal stress at the hanging points to be completely vertical, eliminating any stress inwardly towards the center of the top of the suspended object.

It is yet a further object of the present subject matter to provide a space saving, equal-stress distributing suspending hanger from which a heavy punching bag can be suspended.

These and other objects of the present subject matter are accomplished by providing a space saving, equal-stress distributing suspending hanger which utilizes either a horizontal plate base or a metal bar base having two or more individual bars, and a plurality of hanging points for suspending the object, such as a heavy punching bag, such that the object can be suspended from a lower vertical point and which suspends the object in such a manner that the only stress on the object is at the hanging pins and no force is pulling the upper sides of the object inwardly toward the center of the object.

### BRIEF DESCRIPTION OF DRAWINGS

FIG. 1 is a top perspective view illustrating the open eye bolt embodiment of the space-saving equal stress distribution suspending hanger of the present subject matter suspending a punching bag.

FIG. 2 is top perspective view illustrating the open eye bolt embodiment of the space-saving equal stress distribution suspending hanger of the present subject matter.

FIG. 3 is a bottom perspective view illustrating the open eye bolt embodiment of the space-saving equal stress distribution suspending hanger of the present subject matter.

FIG. 4 is bottom perspective view illustrating the open eye bolt embodiment of the space-saving equal stress distribution suspending hanger of the present subject matter suspending a punching bag.

FIG. 5 is a detached view of the interlocking embodiment of the space-saving equal stress distribution suspending hanger of the present subject matter shown without any securing methods.

FIG. 6 is side perspective view illustrating the interlocking embodiment of the space-saving equal stress distributing suspending hanger of the present subject matter shown with S-hooks as the securing methods.

FIG. 7 is a side perspective illustrating the welded configuration of a four-arm embodiment of the space-saving equal stress distribution suspending hanger of the present subject matter shown with S-hooks as securing methods and four welds, each weld being at the corners where each of the four arms are joined.

FIG. 8 is side perspective view of the U-bolt pairs embodiment of the space-saving equal stress distributing suspending hanger of the present subject matter illustrating a plurality of U-bolt pairs for suspending an object.

FIG. 9 is a top perspective view of the U-bolt pairs embodiment of the space-saving equal stress distributing suspending hanger of the present subject matter illustrating a plurality of U-bolt pairs for suspending an object.

FIG. 10 is a bottom perspective view of the U-bolt pairs embodiment of the space-saving equal stress distributing suspending hanger of the present subject matter.

FIG. 11 is a perspective view of the U-bolt pairs embodiment of the space-saving equal stress distributing suspending hanger of the present subject matter illustrating a plurality of U-bolt pairs and a plurality of strap members suspending a punching bag.

FIG. 12 is a close-up top perspective view of the U-bolts pairs embodiment of the space-saving equal stress distributing suspending hanger of the present subject matter illustrating a plurality of U-bolt pairs and a plurality of strap members suspending a punching bag.

FIG. 13 is side bottom perspective view of the U-bolt pairs embodiment of the space-saving equal stress distributing suspending hanger of the present subject matter illustrating the undercarriage with a plurality of U-bolt pairs and a plurality of strap members for suspending a punching bag.

FIG. 14 is side perspective view of the round disc embodiment of the space-saving equal stress distributing suspending hanger of the present subject matter depicting utilizing S-hooks for securing the object to the suspending hanger.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

It is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

The space saving equal-stress distributing suspending hanger can be configured to accept any type of securing device to a ceiling, suitable securing devices including, but not limited to, quick links, carabiner clips, hoist hooks, lifting hooks, gate hooks, swivel hooks, swivel lifting clevis chain hooks, trigger snaps, snap hooks, halyard snaps, eye bolt snaps, eye boat snaps, eye baby snaps, bull nose snaps, safety snaps, spring hooks, utility snaps, spring snaps, strap members, and the like. Any design configuration that facilitates the suspension of an object using a structure lying in a horizontal plane with respect to a ceiling, rather that a structure lying in a vertical plane, such as a hanging chain, strap, or rope affixed to a point on a ceiling and hanging downwardly therefrom, can be considered as an embodiment of the space saving, equal-stress distributing suspending hanger of the present subject matter.

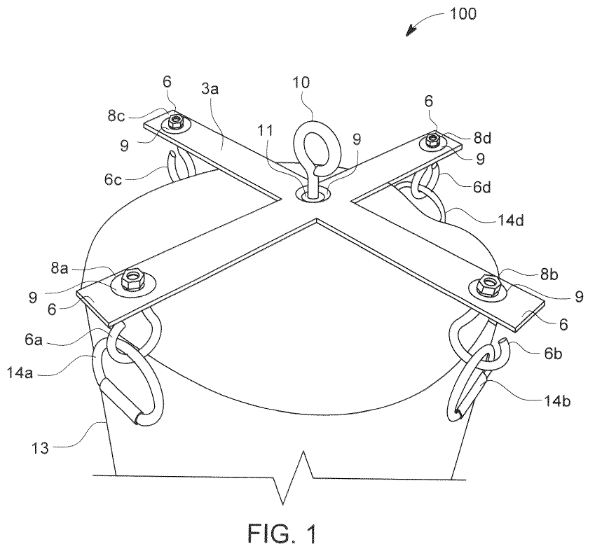

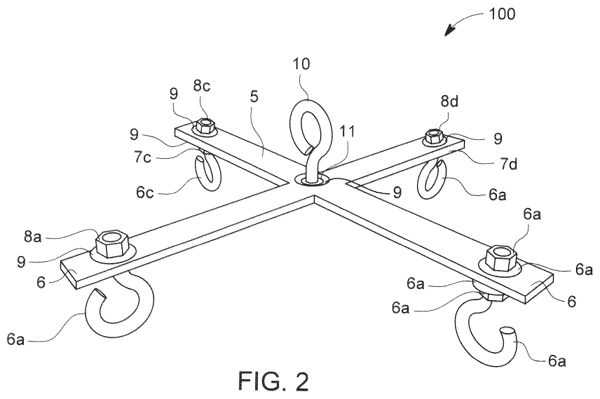

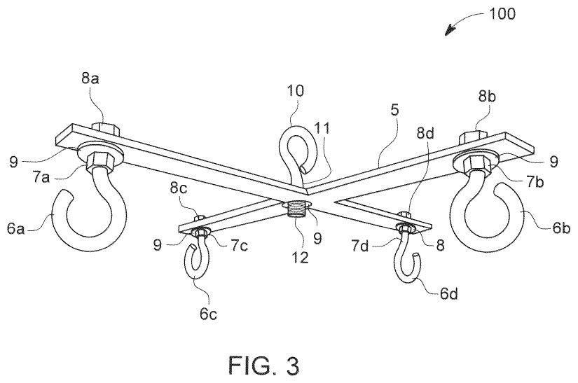

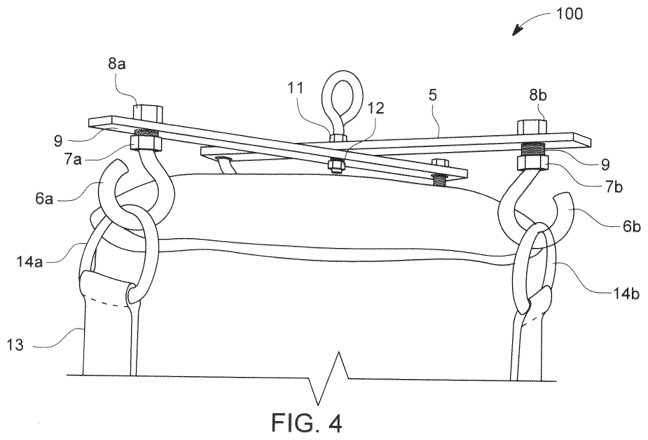

In a first embodiment, the present subject matter is directed space saving equal-stress distributing suspending hanger using a metal bar, a plurality of open eye bolts and D-ringing hanging points. Referring to FIG. 1, FIG. 2, FIG. 3, and FIG. 4, a suspending hanger 100 is shown comprising a top center eyebolt 10 for affixing the suspending hanger 100 to a ceiling, a metal bar base 5 formed in the shape of an X having a central opening 4 for receiving the top center eyebolt 10 and securing it to the metal bar base 5 with a washer 9 and top center eyebolt stabilizing nut 11 and a stop center eyebolt securing nut 12. The metal bar base 5 comprises four (4) bar members each having an end 6 distal from the central opening 4, and one metal bar end open eyebolt 6A, 6B, 6C, and 6D disposed at each of the four metal bar distal ends 6, each metal bar end open eyebolt being secured to one of the distal ends of the metal bar base with a washer 9, a metal bar end open eyebolt stabilizing nut 7A, 7B, 7C, and 7D, and a metal bar end open eyebolt securing stabilizing nut 8A, 8B, 8C, and 8D. Each of the four (4) metal bar end open eyebolts 6A, 6B, 6C, and 6D are engineered to removably receive a D-ring hanging member 14A, 14B, 14C, and 14D respectively. Each of the D-ring hanging members being affixed to an object, such as a punching bag 13.

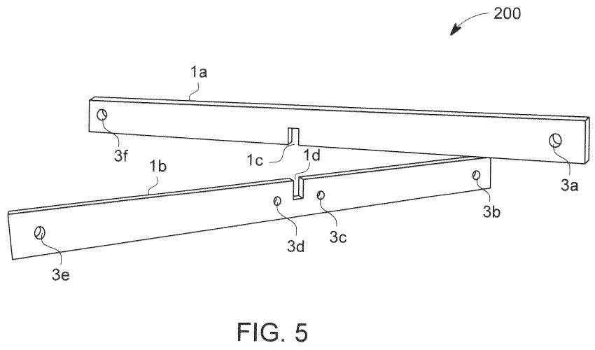

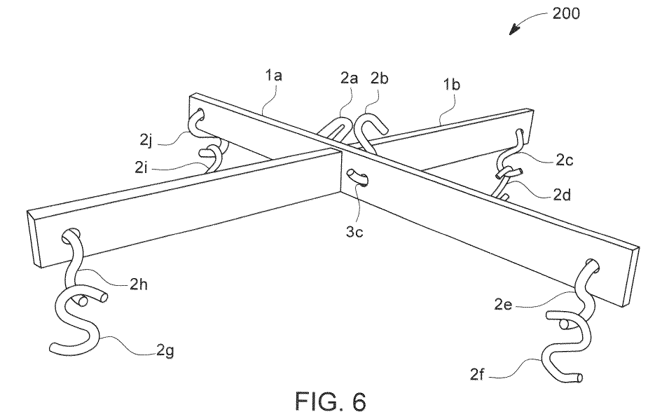

In a second embodiment, the space-saving equal stress distribution suspending hanger of the present subject matter can be in the form of two interlocking bars. As shown in FIG. 5 and FIG. 6, a suspending hanger 200 comprises a pair of interlocking metal bars 1A and 1B, each having a corresponding metal bar notch 1C and 1D, and a plurality of metal bar holes 3A, 3B, 3C, 3D, 3E, and 3F each configured to receive a securing member. As shown in FIG. 6, the securing members are in the form of S-hooks 2A, 2B, 2C, 2D, 2E, 2F, 2G, 2H, 2I, and 2J. S-hook 2A and S-hook 2B are removably secured to metal bar hole 3C and metal bar hole 3D respectively, the S-hooks 2A and 2B are designed to receive a securing mounting device (not shown) for mounting the suspending hanger 200 to a ceiling. S-hooks 2C, 2E, 2H, and 2J are secured to metal bar holes 3A, 3B, 3E, and 3F and S-hooks 2D, 2F, 2G, and 2I are utilized to removably receive a D-ring hanging member (not shown) which is affixed to an object, such as a punching bag, to suspend the punching bag from a ceiling.

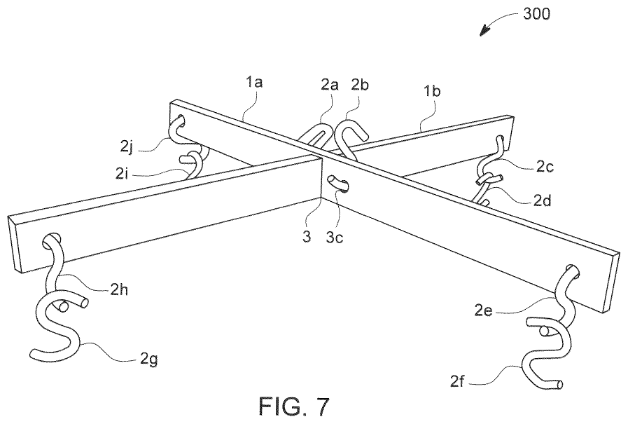

In a third embodiment shown in FIG. 7, a suspending hanger 300 is shown comprising a metal bar base 1A, 1B wherein each metal bar arm is welded at the corner where the arms meet, such as weld 3. In this embodiment, S-hooks 2A and 2B are designed to receive a securing mounting device for mounting the suspending hanger 300 to a ceiling and the remaining S-hooks functionally serve the same purpose as the S-hooks shown in FIG. 5 and FIG. 6.

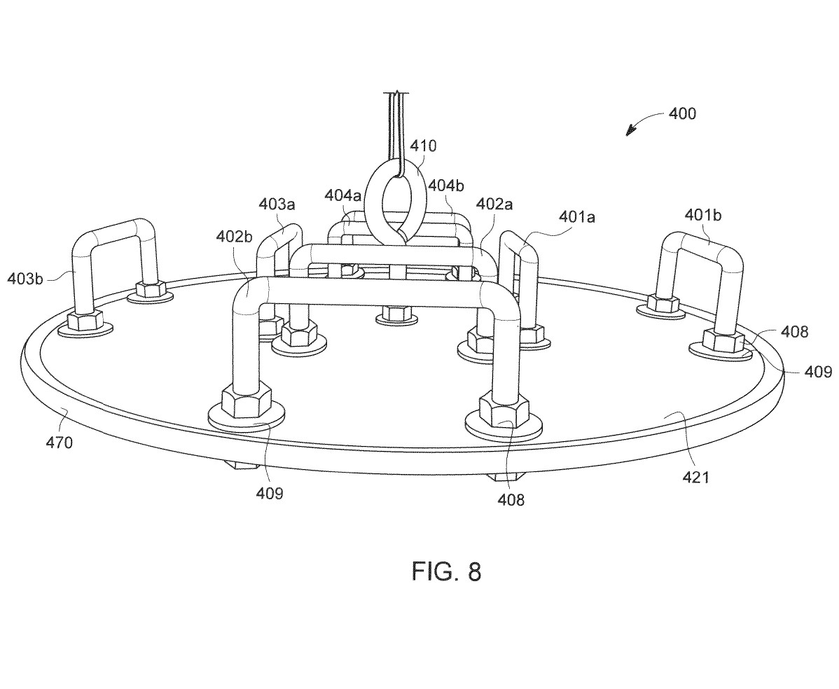

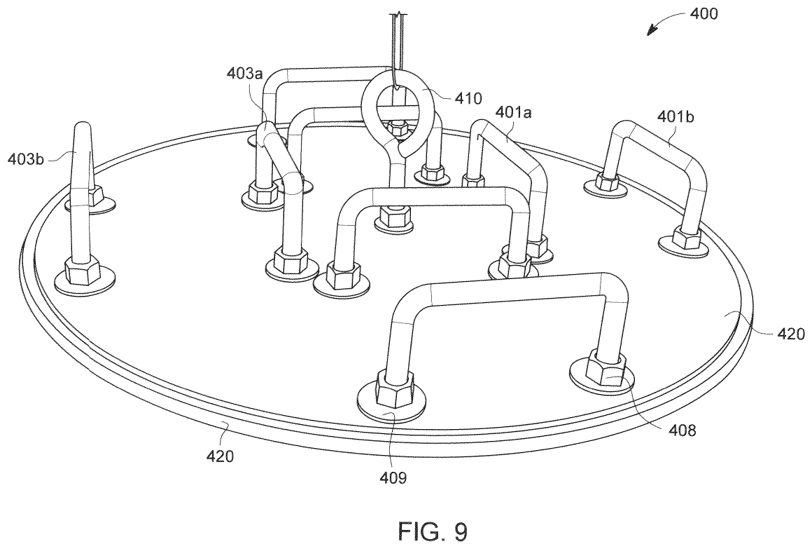

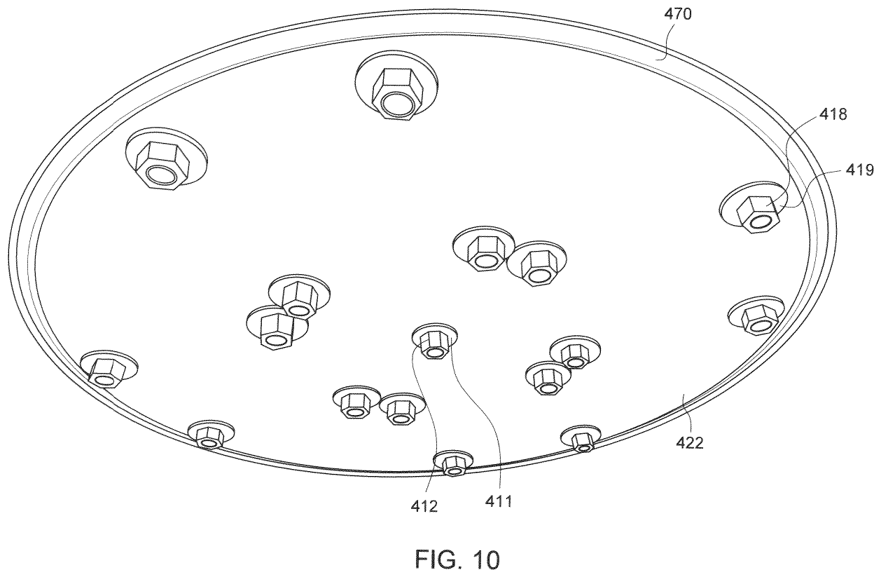

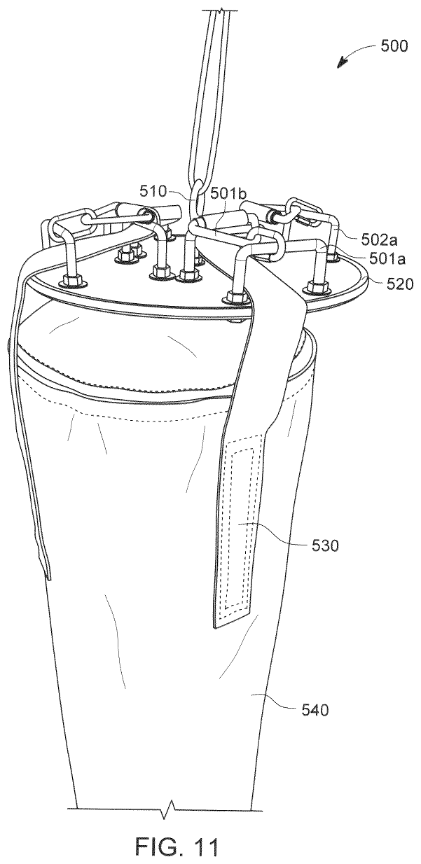

In a fourth embodiment, shown in FIG. 8, FIG. 9 and FIG. 10, the suspending hanger 400 is a circular horizontal plate comprising four (4) pairs of U-bolts 401a paired with 401b, 402a paired with 402b, 403a paired with 403b, and 404a paired with 404b, the four pairs of U-bolts are arranged spatially around circular plate 420 for securing four (4) equidistant sling straps circling the object. The circular plate can be composed of metal or any durable metal alloy or composite having sufficient strength to fasten four pairs of U-bolts therewith. The object preferably is a punching bag (shown in FIG. 11). The circular plate 420 comprises a top surface 421, and undersurface 422, a top center eyelet component 410 for suspending the object to an overhead surface which is secured to the circular plate with a washer 412 and top center eyebolt stabilizing nut 411. The suspending hanger further comprises a plurality of stabilizing nuts 408, stabilizing washers 409, securing washers 419 and securing nuts 418 for securing each of the four pairs of U-bolts to the circular plate.

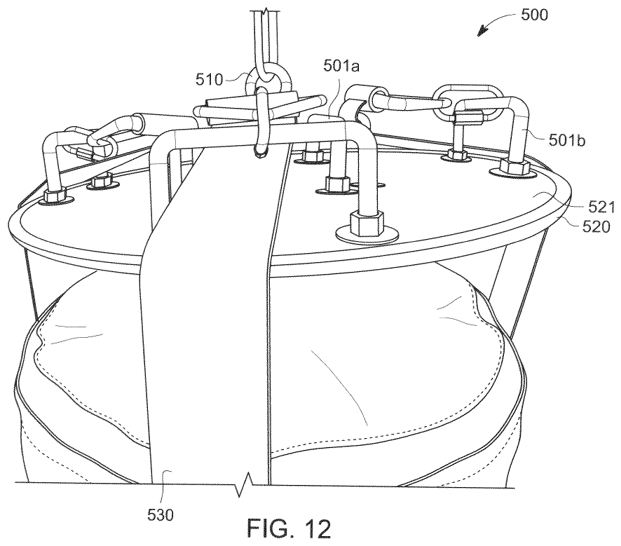

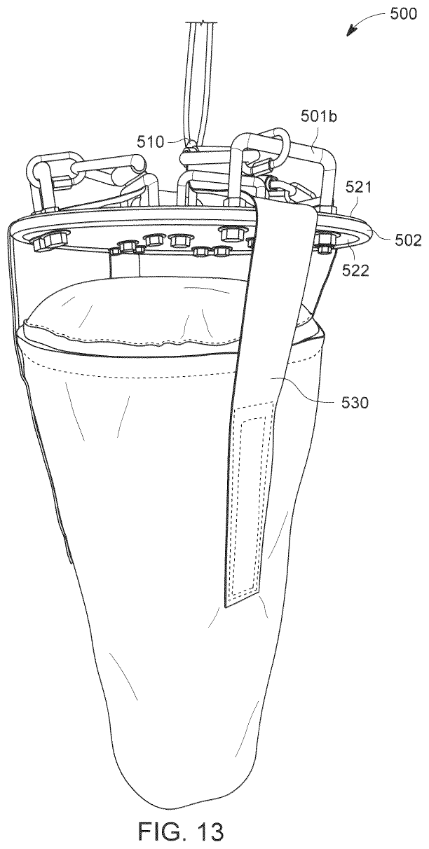

Referring now to FIG. 11, FIG. 12, and FIG. 13, a variation of the suspending hanger 400 is shown wherein the four pairs of U-bolts are depicted as a plurality of U-bolts. In this variation, the suspending hanger 500 comprises a circular plate 520 having a top surface 521, an undersurface 522, a plurality of U-bolt pairs such as 501a paired with 501b, a top center eyelet component 510 and a plurality of sling straps 530, one end of each sling strap being affixed to the object to be suspended, in this variation, the object is a punching bag 540. One end 531 of each of the sling straps 530 affixed to the punching bag, and are spatially arranged around the top/center portion of the punching bag. Each opposite end 532 of each of the sling straps is wrapped about one pair of the U-bolts. This wrapping arrangement of the sling straps around the pair of U-bolts ensures the equal stress distribution of the punching bag such that the top center portion of the punching bag is not pulled inwardly toward the center, forcing the filling retained within the punching bag downwardly towards the lower portion. Rather this configuration ensures that the filling retained within the punching bag is equally distributed.

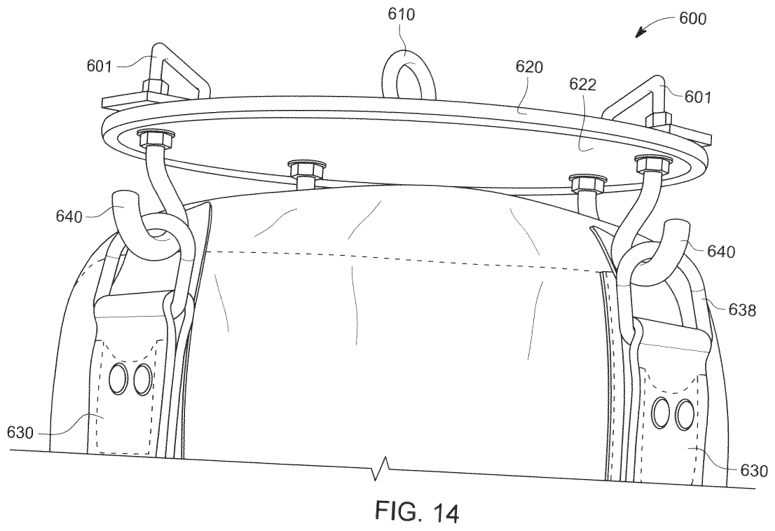

In a sixth embodiment of the space saving equal-stress distributing suspending hanger of the present subject matter, the suspending hanger 600 comprises a circular horizontal plate 620, a plurality of U-bolts 601 secured to the top surface 621 of the plate and a plurality of S-hooks 650 spatially distributed around the undersurface 622 of the circular plate and each S-hook being affixed to one of the plurality of U-bolts 601 by a stabilizing nut and washer arrangement as shown in FIG. 14. The punching bag 640 has a plurality of sling straps 630 affixed to the top center portion, each of the sling straps having a D-ring hanging member 638 which is removably attached to one of the S-hooks 640.

The space saving, equal-stress distributing suspending hanger of the present subject matter eliminates the need for traditional chains, straps, or ropes which place stress inwardly on the hanging points of the suspended object. In addition, the suspending hanger substantially decreases the vertical hanging distance required by a single ceiling mount using chains, straps, or rope, enabling an object to be suspended from a lower vertical point, for example enabling a punching bag to be hung from a lower height than the average height of a standard ceiling.

The prior art consists of either chains, straps, or ropes that grab onto hanging points at the upper sides of the suspended object and force the hanging points inwards towards the center of the suspended object, thereby creating a greater amount of stress on the upper portion of the suspended object. For example, the top portion of a punching bag is pulled inwardly toward the center, forcing the filling retained within the punching bag downwardly towards the lower portion of the punching bag, resulting in a bag that is too soft at the top and too hard at the bottom.

The suspending hanger of the present subject matter suspends the object directly upwards at the hanging points, such that the stress on the object is only at the hanging points and as a result there is no force pulling the upper sides of the object inwardly towards the center. Moreover, the suspending hanger achieves the saving of vertical space by eliminating the traditional chains, straps, or ropes typically used to hang or suspend an object from the top center of the object.

Traditional chains, straps, or ropes that come together above the suspended object, pull the top portion of the suspended object inwardly at the hanging points. The suspending hanger of the present subject matter achieves equal stress at the hanging points to be completely vertical, eliminating any stress inwardly towards the center of the top of the suspended object.

Other embodiments include a metal bar base comprising two or more individual bars which overlap one another, a metal bar base having more than four arms if the object to be suspended has more than four hanging points, a single metal disc may be used in lieu of the metal arms, and a non-metal material may be substituted for the metal bar base. Finally, devices for securing the object to the suspending hanger can be welded onto the metal bar base or metal disc, rather than using open eye bolts, S-hooks, and the like.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for . . . ”

1. A space-saving, equal stress distributing suspending hanger comprising a horizontal plate, four (4) pairs of U-bolts affixed to and arranged spatially around said horizontal plate for securing four (4) equidistant sling straps, each of said sling straps having a distal end affixed to an object to be suspended upwardly and each of said sling straps having a proximal end, each proximal end provided with a hanging point which engages with one of said four pairs of U-bolts to removably secure an object to said space saving, equal stress distributing suspending hanger.

2. The space-saving, equal stress distributing suspending hanger in accordance with claim 1, wherein when an object is suspended therefrom, there is no force pulling the upper sides of the object inwardly toward the center of the object.

3. The space-saving, equal stress distributing suspending hanger in accordance with claim 2, wherein equal-stress distribution enables a heavy object to be suspended from said hanging points.

4. The space-saving, equal stress distributing suspending hanger in accordance with claim 3, wherein the heavy object is a punching bag.

5. The space-saving, equal stress distributing suspending hanger in accordance with claim 4, wherein each proximal end of each of said sling straps is wrapped and secured around one of said U-bolt pairs to ensure the equal stress distribution of the punching bag such that the top center portion of the punching bag is not pulled inwardly toward the center, forcing the filling retained within the punching bag downwardly towards the lower portion of the punching bag.

6. The space-saving, equal stress distributing suspending hanger in accordance with claim 5 wherein each of said four (4) pairs of U-bolts are affixed to said horizontal plate by means of stabilizing nuts.

7. The space-saving, equal stress distributing suspending hanger in accordance with claim 6, further comprising a top center eyelet component affixed to said horizontal plate by means of a stabilizing nut, said top center eyelet component enabling said suspending hanger to be attached to an overhead surface.

8. The space-saving, equal stress distributing suspending hanger in accordance with claim 7, wherein the configuration of said suspending hanger greatly reduces the amount of vertical hanging distance to enable an object to be suspended from a lower overhead surface which would be required by a singular suspension means.

9. The space-saving, equal stress distributing suspending hanger in accordance with claim 5, wherein stress is only at the hanging points defined by the wrapping of said sling straps around said U-bolt pairs.

10. The space-saving, equal stress distributing suspending hanger in accordance with claim 1, wherein said horizontal plate is circular plate composed of metal.

11. A space-saving, equal stress distributing suspending hanger comprising a horizontal plate, a plurality of pairs of U-bolts affixed to and arranged spatially around said horizontal plate for securing a plurality of equidistant sling straps, each of said sling straps having a distal end affixed to an object to be suspended upwardly and each of said sling straps having a proximal end, each proximal end provided with a hanging point which engages with one of said plurality of pairs of U-bolts to removably secure an object to said space saving, equal stress distributing suspending hanger.

12. The space-saving, equal stress distributing suspending hanger in accordance with claim 11, wherein when an object is suspended therefrom, there is no force pulling the upper sides of the object inwardly toward the center of the object.

13. The space-saving, equal stress distributing suspending hanger in accordance with claim 12, wherein equal-stress distribution enables a heavy object to be suspended from said hanging points.

14. The space-saving, equal stress distributing suspending hanger in accordance with claim 13, wherein the heavy object is a punching bag.

15. The space-saving, equal stress distributing suspending hanger in accordance with claim 14, wherein each proximal end of each of said sling straps is wrapped and secured around one of said plurality of U-bolt pairs to ensure the equal stress distribution of the punching bag such that the top center portion of the punching bag is not pulled inwardly toward the center, forcing the filling retained within the punching bag downwardly towards the lower portion of the punching bag.

16. The space-saving, equal stress distributing suspending hanger in accordance with claim 15 wherein each of said plurality of U-bolts pairs are affixed to said horizontal plate by means of stabilizing nuts.

17. The space-saving, equal stress distributing suspending hanger in accordance with claim 16, further comprising a top center eyelet component affixed to said horizontal plate by means of a stabilizing nut, said top center eyelet component enabling said suspending hanger to be attached to an overhead surface.

18. The space-saving, equal stress distributing suspending hanger in accordance with claim 17, wherein the configuration of said suspending hanger greatly reduces the amount of vertical hanging distance to enable an object to be suspended from a lower overhead surface which would be required by a singular suspension means.

19. The space-saving, equal stress distributing suspending hanger in accordance with claim 15, wherein stress is only at the hanging points defined by the wrapping of said sling straps around said U-bolt pairs.

20. The space-saving, equal stress distributing suspending hanger in accordance with claim 11, wherein said horizontal plate is circular plate composed of metal.
